(19) United States
(12) Patent Application Publication
(10) Pub. No.: US 2007/0279741 A1
(43) Pub. Date: Dec. 6, 2007

(54) Polarizing Plate, Optical Film and Image Display

(75) Inventors: Masahiro Yoshioka, Osaka (JP); Minoru Miyatake, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 10/593,787

(22) PCT Filed: Mar. 17, 2005
(86) PCT No.: PCT/JP05/04789

§ 371 Date: Jul. 18, 2007

(30) Foreign Application Priority Data
Mar. 23, 2004 (JP) 2004-084660

(51) Int. Cl. G02B 5/30

(52) U.S. Cl. 359/500; 359/485; 359/494

(57) ABSTRACT

A polarizing plate of the invention comprises a polarizer and a protective film laminated on one or both sides of the polarizer with an adhesive layer, wherein the polarizer comprises a film having a structure having a minute domain dispersed in a matrix formed of an optically-transparent water-soluble resin including an iodine based light absorbing material, and the adhesive layer is made of an adhesive that contains a resin curable with an active energy beam or an active material. The polarizing plate has a high degree of polarization even on the short wavelength side and also has good adhesiveness, and has a good durability and can suppress unevenness in transmittance during black viewing.

### TECHNICAL FIELD

The present invention relates to a polarizing plate. This invention also relates to an optical film using the polarizing plate concerned. Furthermore, this invention relates to an image display, such as a liquid crystal display, an organic electroluminescence display, a CRT and a PDP using the polarizing plate and the optical film concerned.

### BACKGROUND ART

Liquid crystal display are rapidly developing in market, such as in clocks and watches, cellular phones, PDAs, notebook-sized personal computers, and monitor for personal computers, DVD players, TVs, etc. In the liquid crystal display, visualization is realized based on a variation of polarization state by switching of a liquid crystal, where polarizers are used based on a display principle thereof. Particularly, usage for TV etc. increasingly requires display with high luminance and high contrast, polarizers having higher brightness (high transmittance) and higher contrast (high polarization degree) are being developed and introduced.

As polarizers, for example, since it has a high transmittance and a high polarization degree, polyvinyl alcohols having a structure in which iodine is absorbed and then stretched, that is, iodine based polarizers are widely used (for example, Japanese Patent Laid-Open No. 2001-296427). However, since the iodine based polarizers have relatively low polarization degrees in short wavelength side, they have problems in hue, such as blue omission in black viewing, and yellowing in white viewing, in short wavelength side.

Iodine based polarizers may easily give unevenness in a process of iodine absorption. Accordingly, there has been a problem that the unevenness is detected as unevenness in transmittance particularly in the case of black viewing, causing to decrease of visibility. For example, as methods for solving the problems, several methods have been proposed that an amount of absorption of iodine absorbed to the iodine based polarizer is increased and thereby a transmittance in the case of black viewing is set not higher than sensing limitations of human eyes, and that stretching processes generating little unevenness itself are adopted. However, the former method has a problem that it decreases a transmittance in the case of white viewing, while decreasing a transmittance of black viewing, and as a result darkens the display itself. And also, the latter method has a problem that it requires replacing a process itself, worsening productivity.

Conventionally, a polarizer used constitutes a polarizing plate having protective films, such as triacetylcellulose films, bonded to both sides of the polarizer with a polyvinyl alcohol-based adhesive. However, the polyvinyl alcohol-based adhesive has a problem in which on exposure to high temperature and high humidity for a long time, it absorbs the moisture to have a reduced adhesion so that the film can easily peel off or the dimensional stability of the polarizing plate can be reduced, and finally changes in hue can occur in the liquid crystal display.

For example, there is proposed a polarizing plate in which a urethane prepolymer is used as an adhesive to improve the adhesiveness and the resistance to moisture and heat (see Japanese Patent Application Laid-Open No. 07-120617). There is also proposed a method including the steps of using a polyvinyl alcohol-based adhesive that contains a water-soluble epoxy compound and saponifying a triacetylcellulose surface to improve the adhesion (see Japanese Patent Application Laid-Open No. 09-258023). There is also proposed a polarizing plate in which a polarizer and a protective film are bonded together with a thermosetting adhesive so that the adhesiveness and the resistance to moisture and heat are improved (see Japanese Patent Application Laid-Open Nos. 08-101307, 08-216315 and 08-254669). There is also proposed a polarizing plate that uses a polycarbonate film as a protective film instead of triacetylcellulose whose heat resistance is relatively poor so that the adhesiveness and the heat resistance are improved (see Japanese Patent Application Laid-Open No. 08-240716). However, the use of the thermosetting adhesive requires curing under the conditions of high temperature and long time and is likely to have an adverse effect on the optical properties of the polarizer or can lead to a reduction in productivity. In the case where the moisture-curable polyurethane resin is used, the water resistance is insufficient so that the protective film can peel off when the polarizing plate is placed in a hot and humid environment or immersed in water, although the adhesion is strong. In order to solve these problems, a moisture-curable one-component silicone adhesive is proposed (see Japanese Patent No. 3373492).

### DISCLOSURE OF THE INVENTION

An object of the invention is to provide a polarizing plate that includes a polarizer and a protective film laminated on one or both sides of the polarizer and has a high degree of polarization even on the short wavelength side and also has good adhesiveness.

Another object of the invention is to provide a polarizing plate that has a high transmittance, a high degree of polarization and good adhesiveness. Still another object of the invention is to provide a polarizing plate that has a good durability and can suppress unevenness in transmittance during black viewing.

Yet another object of the invention is to provide an optical film using the polarizing plate. A further object of the invention is to provide an image display using the polarizing plate or the optical film.

As a result of examination wholeheartedly performed by the present inventors that the above-mentioned subject should be solved, it was found out that the above-mentioned purpose might be attained using polarizing plates shown below, leading to completion of this invention.

That is, this invention relates to a polarizing plate comprising: a polarizer and a protective film laminated on one or both sides of the polarizer with an adhesive layer, wherein the polarizer comprises a film having a structure having a minute domain dispersed in a matrix formed of an optically-transparent water-soluble resin including an iodine based light absorbing material, and

the adhesive layer is made of an adhesive that contains a resin curable with an active energy beam or an active material.

The minute domain of the above-mentioned polarizer is preferably formed by an oriented birefringent material. The above-mentioned birefringent material preferably shows liquid crystallinity at least in orientation processing step.

The above-mentioned polarizer of this invention has an iodine based polarizer formed by an optically-transparent water-soluble resin and iodine based light absorbing material as a matrix, and has dispersed minute domains in the above-mentioned matrix. Minute domains are preferably formed by oriented materials having birefringence, and particularly minute domains are formed preferably with materials showing liquid crystallinity. Thus, in addition to function of absorption dichroism by iodine based light absorbing materials, characteristics of having function of scattering anisotropy improve polarization performance according to synergistic effect of the two functions, and as a result a polarizer having both of transmittance and polarization degree, and excellent visibility may be provided.

Iodine based light absorbing material means chemical species comprising iodine and absorbs visible light, and it is thought that, in general, they are formed by interaction between optically-transparent water-soluble resins (particularly polyvinyl alcohol based resins) and poly iodine ions (I₃⁻, I₅⁻, etc.). An iodine based light absorbing material is also called an iodine complex. It is thought that poly iodine ions are generated from iodine and iodide ions.

Scattering performance of anisotropic scattering originates in refractive index difference between matrixes and minute domains. For example, if materials forming minute domains are liquid crystalline materials, since they have higher wavelength dispersion of Δn compared with optically-transparent water-soluble resins as a matrix, a refractive index difference in scattering axis becomes larger in shorter wavelength side, and, as a result, it provides more amounts of scattering in shorter wavelength. Accordingly, an improving effect of large polarization performance is realized in shorter wavelengths, compensating a relative low level of polarization performance of an iodine based polarizer in a side of shorter wavelength, and thus a polarizer having high polarization and neutral hue may be realized.

In the polarizing plate of the invention, the adhesive layer for the polarizer and the protective film is made of an adhesive that contains a resin curable with an active energy beam or an active material and thus has good adhesiveness and good durability.

In the above-mentioned polarizing plate, it is preferable that the minute domains of the polarizer have a birefringence of 0.02 or more. In materials used for minute domains, in the view point of gaining larger anisotropic scattering function, materials having the above-mentioned birefringence may be preferably used.

In the above-mentioned polarizing plate, in a refractive index difference between the birefringent material forming the minute domains and the optically-transparent water-soluble resin of the polarizer in each optical axis direction, a refractive index difference (Δn¹) in direction of axis showing a maximum is 0.03 or more, and a refractive index difference (Δn²) between the Δn¹ direction and a direction of axes of two directions perpendicular to the Δn¹ direction is 50% or less of the Δn¹.

Control of the above-mentioned refractive index difference (Δn¹) and (Δn²) in each optical axis direction into the above-mentioned range may provide a scattering anisotropic film having function being able to selectively scatter only linearly polarized light in the Δn¹ direction, as is submitted in U.S. Pat. No. 2,123,902 specification. That is, on one hand, having a large refractive index difference in the Δn¹ direction, it may scatter linearly polarized light, and on the other hand, having a small refractive index difference in the Δn² direction, and it may transmit linearly polarized light. Moreover, refractive index differences (Δn²) in the directions of axes of two directions perpendicular to the Δn¹ direction are preferably equal.

In order to obtain high scattering anisotropy, a refractive index difference (Δn¹) in Δn¹ direction is set 0.03 or more, preferably 0.05 or more, and still preferably 0.10 or more. A refractive index difference (Δn²) in two directions perpendicular to the Δn¹ direction is 50% or less of the above-mentioned Δn¹, and preferably 30% or less.

In the above-mentioned polarizing plate, iodine based light absorbing material of the polarizer; an absorption axis of the material concerned preferably is orientated in the Δn¹ direction.

The iodine based light absorbing material in a matrix is orientated so that an absorption axis of the material may become parallel to the above-mentioned Δn¹ direction, and thereby linearly polarized light in the Δn¹ direction as a scattering polarizing direction may be selectively absorbed. As a result, on one hand, a linearly polarized light component of incident light in Δn² direction is not scattered or hardly absorbed by the iodine based light absorbing material as in conventional iodine based polarizers without anisotropic scattering performance. On the other hand, a linearly polarized light component in the Δn¹ direction is scattered, and is absorbed by the iodine based light absorbing material. Usually, absorption is determined by an absorption coefficient and a thickness. In such a case, scattering of light greatly lengthens an optical path length compared with a case where scattering is not given. As a result, polarized component in the Δn¹ direction is more absorbed as compared with a case in conventional iodine based polarizers. That is, higher polarization degrees may be attained with same transmittances.

Descriptions for ideal models will, hereinafter, be given. Two main transmittances usually used for linear polarizer (a first main transmittance k₁(a maximum transmission direction=linearly polarized light transmittance in Δn² direction), a second main transmittance k₂ (a minimum transmission direction=linearly polarized light transmittance in Δn¹ direction)) are, hereinafter, used to give discussion.

In commercially available iodine based polarizers, when iodine based light absorbing materials are oriented in one direction, a parallel transmittance and a polarization degree may be represented as follows, respectively:
parallel transmittance=0.5×((k₁)²+(k₂)²) and
polarization degree=(k₁−k₂)/(k₁+k₂).

On the other hand, when it is assumed that, in a polarizer of this invention, a polarized light in a Δn¹ direction is scattered and an average optical path length is increased by a factor of α(>1), and depolarization by scattering may be ignored, main transmittances in this case may be represented as k₁ and k₂′=10×(where, x is αlog k₂), respectively

That is, a parallel transmittance in this case and the polarization degree are represented as follows:
parallel transmittance=0.5×((k₁)²+(k₂′)²) and
polarization degree=(k₁−k₂′)/(k₁+k₂).

When a polarizer of this invention is prepared by a same condition (an amount of dyeing and production procedure are same) as in commercially available iodine based polarizers (parallel transmittance 0.385, polarization degree 0.965: k₁=0.877, k₂=0.016), on calculation, when α is 2 times, k₂ becomes small reaching 0.0003, and as result, a polarization degree improves up to 0.999, while a parallel transmittance is maintained as 0.385. The above-mentioned result is on calculation, and function may decrease a little by effect of depolarization caused by scattering, surface reflection, backscattering, etc. As the above-mentioned equations show, higher value a may give better results and higher dichroic ratio of the iodine based light absorbing material may provide higher function. In order to obtain higher value α, a highest possible scattering anisotropy function may be realized and polarized light in Δn¹ direction may just be selectively and strongly scattered. Besides, less backscattering is preferable, and a ratio of backscattering strength to incident light strength is preferably 30% or less, and more preferably 20% or less.

In the above-mentioned polarizing plate, the film used as the polarizer manufactured by stretching may suitably be used.

In the above-mentioned polarizing plate, the minute domains of the polarizer preferably have a length in Δn² direction of 0.05 to 500 μm.

In order to scatter strongly linearly polarized light having a plane of vibration in a Δn¹ direction in wavelengths of visible light band, dispersed minute domains have a length controlled to 0.05 to 500 μm in a Δn² direction, and preferably controlled to 0.5 to 100 μm. When the length in the Δn² direction of the minute domains is too short a compared with wavelengths, scattering may not fully provided. On the other hand, when the length in the Δn² direction of the minute domains is too long, there is a possibility that a problem of decrease in film strength or of liquid crystalline material forming minute domains not fully oriented in the minute domains may arise.

In the above-mentioned polarizing plate, iodine based light absorbing materials of the polarizer having an absorption band at least in a wavelength range of 400 to 700 nm may be used.

In the above-mentioned polarizing plate, the adhesive is preferably a material that does not require a mixing process before coating or a drying process after coating, such as an active energy beam-curable solventless adhesive and a moisture-curable one-component adhesive. Such an adhesive is advantageous for the manufacturing process. The active energy beam-curable solventless adhesive is characterized in that particularly by the use of high energy beams such as electron beams, it can be cured faster than the thermosetting type, defects such as insufficient crosslinking can also be reduced, and the crosslink density can easily be increased. The moisture-curable adhesive also has good adhesion properties. Thus, the polarizing plate produced with any of these adhesives can have good durability such as resistance to moisture and heat. An ultraviolet-curable or electron beam-curable adhesive such as an acrylic, epoxy or urethane adhesive is preferably used as the active energy beam-curable solventless adhesive. In particular, the electron beam-curable adhesive is advantageous in terms of productivity or cost, because it can facilitate high speed curing and does not require the addition of any curing initiator or the like. A one-component silicone adhesive is preferably used as the moisture-curable one-component adhesive. This adhesive can form a polarizing plate with high optical performance, because it has good adhesiveness to the polarizer and can form a highly transparent adhesive layer with no optical anisotropy. The moisture-curable adhesive can be cured with moisture at room temperature and thus can be cured with water from the polarizer (polyvinyl alcohol) even when it is sealed with a protective film. In order to increase the adhesiveness, a polyvinyl alcohol-based polarizer with a water content of at least 1% by mass is preferably used.

In the above-mentioned polarizing plate, the protective film preferably has a bonded surface that has been subjected to at least one treatment selected from corona treatment, plasma treatment, flame treatment, primer coating treatment, and saponification treatment.

In the above-mentioned polarizing plate, the protective film preferably has an in-plane retardation Re=(nx−ny)×d is preferably 20 nm or less, and a thickness direction retardation Rth={(nx+ny)/2−nz}×d is preferably 30 nm or less, where a direction of a transparent protective film where an in-plane refractive index within the film surface concerned gives a maximum is defined as X-axis, a direction perpendicular to X-axis is defined as Y-axis, a thickness direction of the film is defined as Z-axis, refractive indices in axial direction are defined as nx, ny, and nz, respectively, and a thickness of the film is defined as d (nm).

The protective film such as a triacetylcellulose film has a certain retardation value and thus can have a problem with hue, but if the retardation is small as described above, the optical coloration problem associated with the protective film can be almost eliminated. The protective film preferably has an in-plane retardation is 20 nm or less, more preferably 10 nm or less, and preferably has a thickness direction retardation 30 nm or less, more preferably 20 nm or less.

As the protective film, preferably used is at least one selected from a resin composition containing a thermoplastic resin (A) having a substituted and/or non-substituted imide group in a side chain and a thermoplastic resin (B) having substituted and/or non-substituted phenyl group and nitrile group in a side chain, and the norbornene resin. Also at least one selected from a polyolefin based resin, polyester based resin and polyamide based is preferably used.

A transparent film comprising the above materials can provide a stable retardation value, even when a polarizer has some dimensional variation and, as a result, receives a stress caused by high temperature and high humidity under conditions of high temperature and high humidity. That is, an optical film that hardly gives retardation under high temperature and high humidity environment and gives little characteristic variation may be obtained. Particularly, a transparent film including a mixture of the above-mentioned thermoplastic resins (A) and (B) is preferable.

Generally, strength of a film material may improve, and tougher mechanical characteristic can be realized if the film is stretched. In many materials, since stretching processing causes retardation, it cannot be used as a protective film for a polarizer. Even when stretching processing is given, a transparent film including a mixture of the thermoplastic resins (A) and (B) components may provide a satisfactory in-plane retardation and a satisfactory thickness direction retardation described above. Stretching processing may be given by any of uniaxial stretching and biaxial stretching. Especially a film treated by biaxial stretching is preferable.

In the above-mentioned polarizing plates, a transmittance to a linearly polarized light in a transmission direction is 80% or more, a haze value is 5% or less, and a haze value to a linearly polarized light in an absorption direction is 30% or more.

A polarizing plate of this invention having the above-mentioned transmittance and haze value has a high transmittance and excellent visibility for linearly polarized light in a transmission direction, and has strong optical diffusibility for linearly polarized light in an absorption direction. Therefore, without sacrificing other optical properties and using a simple method, it may demonstrate a high transmittance and a high polarization degree, and may control unevenness of the transmittance in the case of black viewing. Namely, unevenness caused by localized amount of scatter in transmittance is suppressed with the scattering in the case of black viewing, and clear image is provided with no scattering in the case of white viewing, that is, the good visibility is obtained, thus the above polarizing plate is applied to liquid crystal display and the like, light leakage observed from front and oblique is reduced

It is preferable that the polarizing plate of this invention has as high as possible transmittance to linearly polarized light in a transmission direction, that is, linearly polarized light in a direction perpendicular to a direction of maximal absorption of the above-mentioned iodine based light absorbing material, and that has 80% or more of light transmittance when an optical intensity of incident linearly polarized light is set to 100. The light transmittance is preferably 85% or more, and still preferably 88% or more. Here, a light transmittance is equivalent to a value Y calculated from a spectral transmittance in 380 nm to 780 nm measured using a spectrophotometer with an integrating sphere based on CIE 1931 XYZ standard colorimetric system. In addition, since about 8% to 10% is reflected by an air interface on a front surface and rear surface of the polarizing plate, an ideal limit is a value in which a part for this surface reflection is deducted from 100%.

It is desirable that the polarizing plate does not scatter linearly polarized light in a transmission direction in the view point of obtaining clear visibility of a display image. Accordingly, the polarizing plate preferably has 5% or less of haze value to the linearly polarized light in the transmission direction, more preferably 3% or less, and still more preferably 1% or less. On the other hand, in the view point of covering unevenness by a local transmittance variation by scattering, the polarizing plate desirably scatters strongly linearly polarized light in an absorption direction, that is, linearly polarized light in a direction for a maximal absorption of the above-mentioned iodine based light absorbing material. Accordingly, a haze value to the linearly polarized light in the absorption direction is preferably 30% or more, more preferably 40% or more, and still more preferably 50% or more. In addition, the haze value here is measured based on JIS K 7136 (how to obtain a haze of plastics-transparent material).

The above-mentioned optical properties are obtained by compounding a function of scattering anisotropy with a function of an absorption dichroism of the polarizer. As is indicated in U.S. Pat. No. 2,123,902 specification, Japanese Patent Laid-Open No. 9-274108, and Japanese Patent Laid-Open No. 9-297204, same characteristics may probably be attained also in a way that a scattering anisotropic film having a function to selectively scatter only linearly polarized light, and a dichroism absorption type polarizer are superimposed in an axial arrangement so that an axis providing a greatest scattering and an axis providing a greatest absorption may be parallel to each other. These methods, however, require necessity for separate formation of a scattering anisotropic film, have a problem of precision in axial joint in case of superposition, and furthermore, a simple superposition method does not provide increase in effect of the above-mentioned optical path length of the polarized light absorbed as is expected, and as a result, the method cannot easily attain a high transmission and a high polarization degree.

Besides, this invention relates to an optical film comprising at least one of the above-mentioned polarizing plate.

Moreover, this invention relates to an image display comprising at least one selected from the polarizing plate or the above-mentioned optical film.

### BRIEF DESCRIPTION OF DRAWINGS

FIG. 1 is conceptual top view showing an example of a polarizer of this invention;

FIG. 2 is graph showing polarized light absorption spectra of polarizers in Example 1 and Comparative example 6.

### BEST MODE FOR CARRYING OUT THE INVENTION

A polarizing plate of this invention comprising a polarizer and a protective film laminated on one or both sides of the polarizer.

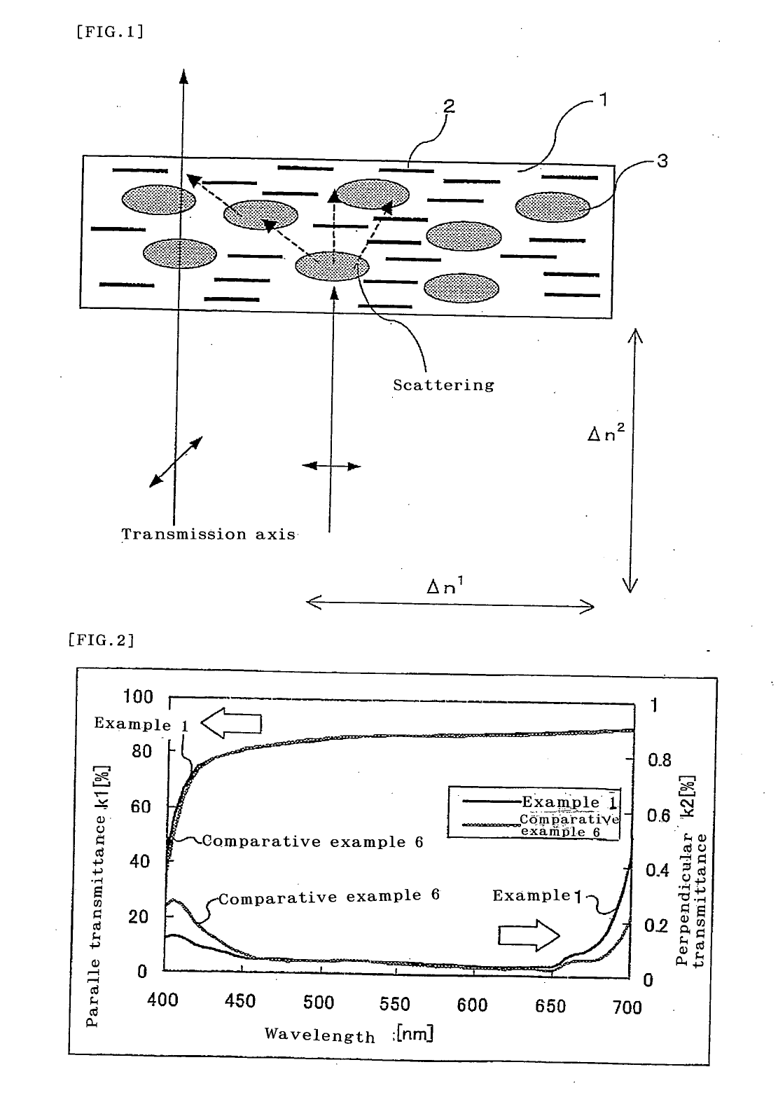

A polarizer of this invention will, hereinafter, be described referring to drawings. FIG. 1 is a conceptual top view of a polarizer of this invention, and the polarizer has a structure where a film is formed with an optically-transparent water-soluble resin 1 including iodine based light absorbing material 2, and minute domains 3 are dispersed in the film concerned as a matrix.

FIG. 1 shows an example of a case where the iodine based light absorbing material 2 is oriented in a direction of axis (Δn¹ direction) in which a refractive index difference between the minute domain 3 and the optically-transparent water-soluble resin 1 shows a maximal value. In minute domain 3, a polarized component in the Δn¹ direction are scattered. In FIG. 1, the Δn¹ direction in one direction in a film plane is an absorption axis. In the film plane, a Δn² direction perpendicular to the Δn¹ direction serves as a transmission axis. Another Δn² direction perpendicular to the Δn¹ direction is a thickness direction.

As optically-transparent water-soluble resins 1, resins having optically-transparency in a visible light band and dispersing and absorbing the iodine based light absorbing materials may be used without particular limitation. For example, polyvinyl alcohols or derivatives thereof conventionally used for polarizers may be mentioned. As derivatives of polyvinyl alcohol, polyvinyl formals, polyvinyl acetals, etc. may be mentioned, and in addition derivatives modified with olefins, such as ethylene and propylene, and unsaturated carboxylic acids, such as acrylic acid, methacrylic acid, and crotonic acid, alkyl esters of unsaturated carboxylic acids, acrylamides etc. may be mentioned. Besides, as optically-transparent water-soluble resin 1, for example, polyvinyl pyrrolidone based resins, amylose based resins, etc. may be mentioned. The above-mentioned optically-transparent water-soluble resin may be of resins having isotropy not easily generating orientation birefringence caused by molding deformation etc., and of resins having anisotropy easily generating orientation birefringence.

In materials forming minute domains 3, it is not limited whether the material has birefringence or isotropy, but materials having birefringence is particularly preferable. Moreover, as materials having birefringence, materials (henceforth, referred to as liquid crystalline material) showing liquid crystallinity at least at the time of orientation treatment may preferably used. That is, the liquid crystalline material may show or may lose liquid crystallinity in the formed minute domain 3, as long as it shows liquid crystallinity at the orientation treatment time.

As materials forming minute domains 3, materials having birefringences (liquid crystalline materials) may be any of materials showing nematic liquid crystallinity, smectic liquid crystallinity, and cholesteric liquid crystallinity, or of materials showing lyotropic liquid crystallinity. Moreover, materials having birefringence may be of liquid crystalline thermoplastic resins, and may be formed by polymerization of liquid crystalline monomers. When the liquid crystalline material is of liquid crystalline thermoplastic resins, in the view point of heat-resistance of structures finally obtained, resins with high glass transition temperatures may be preferable. Furthermore, it is preferable to use materials showing glass state at least at room temperatures. Usually, a liquid crystalline thermoplastic resin is oriented by heating, subsequently cooled to be fixed, and forms minute domains 3 while liquid crystallinity are maintained. Although liquid crystalline monomers after orienting can form minute domains 3 in the state of fixed by polymerization, cross-linking, etc., some of the formed minute domains 3 may lose liquid crystallinity.

As the above-mentioned liquid crystalline thermoplastic resins, polymers having various skeletons of principal chain types, side chain types, or compounded types thereof may be used without particular limitation. As principal chain type liquid crystal polymers, polymers, such as condensed polymers having structures where mesogen groups including aromatic units etc. are combined, for example, polyester based, polyamide based, polycarbonate based, and polyester imide based polymers, may be mentioned. As the above-mentioned aromatic units used as mesogen groups, phenyl based, biphenyl based, and naphthalene based units may be mentioned, and the aromatic units may have substituents, such as cyano groups, alkyl groups, alkoxy groups, and halogen groups.

As side chain type liquid crystal polymers, polymers having principal chain of, such as polyacrylate based, polymethacrylate based, poly-alpha-halo acrylate based, poly-alpha-halo cyano acrylate based, polyacrylamide based, polysiloxane based, and poly malonate based principal chain as a skeleton, and having mesogen groups including cyclic units etc. in side chains may be mentioned. As the above-mentioned cyclic units used as mesogen groups, biphenyl based, phenyl benzoate based, phenylcyclohexane based, azoxybenzene based, azomethine based, azobenzene based, phenyl pyrimidine based, diphenyl acetylene based, diphenyl benzoate based, bicyclo hexane based, cyclohexylbenzene based, terphenyl based units, etc. may be mentioned. Terminal groups of these cyclic units may have substituents, such as cyano group, alkyl group, alkenyl group, alkoxy group, halogen group, haloalkyl group, haloalkoxy group, and haloalkenyl group. Groups having halogen groups may be used for phenyl groups of mesogen groups.

Besides, any mesogen groups of the liquid crystal polymer may be bonded via a spacer part giving flexibility. As spacer parts, polymethylene chain, polyoxymethylene chain, etc. may be mentioned. A number of repetitions of structural units forming the spacer parts is suitably determined by chemical structure of mesogen parts, and the number of repeating units of polymethylene chain is 0 to 20, preferably 2 to 12, and the number of repeating units of polyoxymethylene chain is 0 to 10, and preferably 1 to 3.

The above-mentioned liquid crystalline thermoplastic resins preferably have glass transition temperatures of 50° C. or more, and more preferably 80° C. or more. Furthermore they have approximately 2,000 to 100,000 of weight average molecular weight.

As liquid crystalline monomers, monomers having polymerizable functional groups, such as acryloyl groups and methacryloyl groups, at terminal groups, and further having mesogen groups and spacer parts including the above-mentioned cyclic units etc. may be mentioned. Crossed-linked structures may be introduced using polymerizable functional groups having two or more acryloyl groups, methacryloyl groups, etc., and durability may also be improved.

Materials forming minute domains 3 are not entirely limited to the above-mentioned liquid crystalline materials, and non-liquid crystalline resins may be used if they are different materials from the matrix materials. As the above-mentioned resins, polyvinyl alcohols and derivatives thereof, polyolefins, polyarylates, polymethacrylates, polyacrylamides, polyethylene terephthalates, acrylic styrene copolymes, etc. may be mentioned. Moreover, particles without birefringence may be used as materials for forming the minute domains 3. As fine-particles concerned, resins, such as polyacrylates and acrylic styrene copolymers, may be mentioned. A size of the fine-particles is not especially limited, and particle diameters of 0.05 to 500 μm may be used, and preferably 0.5 to 100 μm. Although it is preferable that materials for forming minute domains 3 is of the above-mentioned liquid crystalline materials, non-liquid crystalline materials may be mixed and used to the above-mentioned liquid crystalline materials. Furthermore, as materials for forming minute domains 3, non-liquid crystalline materials may also be independently used.

Iodine based light absorbing material is used in this invention, examples of the absorbing dichroic material for use as an alternative to the iodine based light absorbing material include absorbing dichroic dyes, absorbing dichroic pigments and the like. In the invention, iodine based light absorbing materials are preferably used as the absorbing dichroic material. In the case where the optically-transparent resin 1 used as the matrix material is a water-soluble resin such as polyvinyl alcohol, iodine based light absorbing materials are particularly preferred in terms of high degree of polarization and high transmittance.

Preferably used are absorbing dichroic dyes that have heat resistance and do not lose their dichroism by decomposition or degradation even when the birefringent liquid-crystalline material is aligned by heating. As described above, the absorbing dichroic dye preferably has at least one absorption band with a dichroic ratio of at least 3 in the visible wavelength range. In the evaluation of the dichroic ratio, for example, an appropriate liquid crystal material containing a dissolved dye is used to form a homogeneously aligned liquid crystal cell, and the cell is measured for a polarized absorption spectrum, in which the absorption dichroic ratio at the absorption maximum wavelength is used as an index for evaluating the dichroic ratio. In this evaluation method, E-7 manufactured by Merck & Co. may be used as a standard liquid crystal. In this case, the dye to be used should generally have a dichroic ratio of at least about 3, preferably of at least about 6, more preferably of at least about 9, at the absorption wavelength.

Examples of the dye having such a high dichroic ratio include azo dyes, perylene dyes and anthraquinone dyes, which are preferably used for dye polarizers. Any of these dyes may be used in the form of a mixed dye. For example, these dyes are described in detail in JP-A No. 54-76171.

In the case where a color polarizer is produced, a dye having an absorption wavelength appropriate to the properties of the polarizer may be used. In the case where a neutral gray polarizer is produced, two or more types of dyes may be appropriately mixed such that absorption can occur over the whole visible light range.

In a polarizer of this invention, while producing a film in which a matrix is formed with an optically-transparent water-soluble resin 1 including an iodine based light absorbing material 2, minute domains 3 (for example, an oriented birefringent material formed with liquid crystalline materials) are dispersed in the matrix concerned. Moreover, the above-mentioned refractive index difference (Δn¹) in a Δn¹ direction and a refractive index difference (Δn²) in a Δn² direction are controlled to be in the above-mentioned range in the film.

Manufacturing process of a polarizer of this invention is not especially limited, and for example, the polarizer of this invention may be obtained using following production processes:
(1) a process for manufacturing a mixed solution in which a material for forming minute domains is dispersed in an optically-transparent water-soluble resin forming a matrix (description is, hereinafter, to be provided, with reference to an example of representation, for a case where a liquid crystalline material is used as a material forming the minute domains. A case by a liquid crystalline material will apply to a case by other materials.);
(2) a process in which a film is formed with the mixed solution of the above-mentioned (1);
(3) a process in which the film obtained in the above-mentioned (2) is oriented (stretched); and
(4) a process in which an iodine based light absorbing material is dispersed (dyed) in the optically-transparent water-soluble resin forming the above-mentioned matrix.
In addition, an order of the processes (1) to (4) may suitably be determined.

In the above-mentioned process (1), a mixed solution is firstly prepared in which a liquid crystalline material forming minute domains is dispersed in an optically-transparent water-soluble resin forming a matrix. A method for preparing the mixed solution concerned is not especially limited, and a method may be mentioned of utilizing a phase separation phenomenon between the above-mentioned matrix component (an optically-transparent water-soluble resin) and a liquid crystalline material. For example, a method may be mentioned in which a material having poor compatibility between the matrix component as a liquid crystalline material is selected, a solution of the material forming the liquid crystalline material is dispersed using dispersing agents, such as a surface active agent, in a water solution of the matrix component. In preparation of the above-mentioned mixed solution, some of combinations of the optically-transparent material forming the matrix, and the liquid crystal material forming minute domains do not require a dispersing agent. An amount used of the liquid crystalline material dispersed in the matrix is not especially limited, and a liquid crystalline material is 0.01 to 100 parts by weight to an optically-transparent water-soluble resin 100 parts by weight, and preferably it is 0. 1 to 10 parts by weight. The liquid crystalline material is used in a state dissolved or not dissolved in a solvent. Examples of solvents, for example, include: water, toluene, xylene, hexane cyclohexane, dichloromethane, trichloromethane, dichloroethane, trichloroethane, tetrachloroethane, trichloroethylene, methyl ethyl ketone, methylisobutylketone, cyclohexanone, cyclopentanone, tetrahydrofuran, ethyl acetate, etc. Solvents for the matrix components and solvents for the liquid crystalline materials may be of same, or may be of different solvents.

In the above-mentioned process (2), in order to reduce foaming in a drying process after a film formation, it is desirable that solvents for dissolving the liquid crystalline material forming a minute domains is not used in preparation of the mixed solution in the process (1). When solvents are not used, for example, a method may be mentioned in which a liquid crystalline material is directly added to an aqueous solution of an optically transparency material forming a matrix, and then is heated above a liquid crystal temperature range in order to disperse the liquid crystalline material uniformly in a smaller state.

In addition, a solution of a matrix component, a solution of a liquid crystalline material, or a mixed solution may include various kinds of additives, such as dispersing agents, surface active agents, ultraviolet absorption agents, flame retardants, antioxidants, plasticizers, mold lubricants, other lubricants, and colorants in a range not disturbing an object of this invention.

In the process (2) for obtaining a film of the above-mentioned mixed solution, the above-mentioned mixed solution is heated and dried to remove solvents, and thus a film with minute domains dispersed in the matrix is produced. As methods for formation of the film, various kinds of methods, such as casting methods, extrusion methods, injection molding methods, roll molding methods, and flow casting molding methods, may be adopted. In film molding, a size of minute domains in the film is controlled to be in a range of 0.05 to 500 μm in a Δn² direction. Sizes and dispersibility of the minute domains may be controlled, by adjusting a viscosity of the mixed solution, selection and combination of the solvent of the mixed solution, dispersant, and thermal processes (cooling rate) of the mixed solvent and a rate of drying. For example, a mixed solution of an optically-transparent water-soluble resin that has a high viscosity and generates high shearing force and that forms a matrix, and a liquid crystalline material forming minute domains is dispersed by agitators, such as a homogeneous mixer, being heated at a temperature in no less than a range of a liquid crystal temperature, and thereby minute domains may be dispersed in a smaller state.

The process (3) giving orientation to the above-mentioned film may be performed by stretching the film. In stretching, uniaxial stretching, biaxial stretching, diagonal stretching are exemplified, but uniaxial stretching is usually performed. Any of dries type stretching in air and wet type stretching in an aqueous system bath may be adopted as the stretching method. When adopting a wet type stretching, an aqueous system bath may include suitable additives (boron compounds, such as boric acid; iodide of alkali metal, etc.) A stretching ratio is not especially limited, and in usual a ratio of approximately 2 to 10 times is preferably adopted.

This stretching may orient the iodine based light absorbing material in a direction of stretching axis. Moreover, the liquid crystalline material forming a birefringent material is oriented in the stretching direction in minute domains by the above-mentioned stretching, and as a result birefringence is demonstrated.

It is desirable the minute domains may be deformed according to stretching. When minute domains are of non-liquid crystalline materials, approximate temperatures of glass transition temperatures of the resins are desirably selected as stretching temperatures, and when the minute domains are of liquid crystalline materials, temperatures making the liquid crystalline materials exist in a liquid crystal state such as nematic phase or smectic phase or an isotropic phase state, are desirably selected as stretching temperatures. When inadequate orientation is given by stretching process, processes, such as heating orientation treatment, may separately be added.

In addition to the above-mentioned stretching, function of external fields, such as electric field and magnetic field, may be used for orientation of the liquid crystalline material. Moreover, liquid crystalline materials mixed with light reactive substances, such as azobenzene, and liquid crystalline materials having light reactive groups, such as a cinnamoyl group, introduced thereto are used, and thereby these materials may be oriented by orientation processing with light irradiation etc. Furthermore, a stretching processing and the above-mentioned orientation processing may also be used in combination. When the liquid crystalline material is of liquid crystalline thermoplastic resins, it is oriented at the time of stretching, cooled at room temperatures, and thereby orientation is fixed and stabilized. Since target optical property will be demonstrated if orientation is carried out, the liquid crystalline monomer may not necessarily be in a cured state. However, in liquid crystalline monomers having low isotropic transition temperatures, a few temperature rise provides an isotropic state. In such a case, since anisotropic scattering may not be demonstrated but conversely polarized light performance deteriorates, the liquid crystalline monomers are preferably cured. Besides, many of liquid crystalline monomers will be crystallized when left at room temperatures, and then they will demonstrate anisotropic scattering and polarized light performance conversely deteriorate, the liquid crystalline monomers are preferably cured. In the view point of these phenomena, in order to make orientation state stably exist under any kind of conditions, liquid crystalline monomers are preferably cured. In curing of a liquid crystalline monomer, for example, after the liquid crystalline monomer is mixed with photopolymerization initiators, dispersed in a solution of a matrix component and oriented, in either of timing (before dyed or after dyed by iodine based light absorbing materials), the liquid crystalline monomer is cured by exposure with ultraviolet radiation etc. to stabilize orientation. Desirably, the liquid crystalline monomer is cured before dyed with iodine based light absorbing materials.

As a process (4) in which the iodine based light absorbing material is dispersed in the optically-transparent water-soluble resin used for forming the above-mentioned matrix, in general, a method in which the above-mentioned film is immersed into a bath of aqueous system including iodine dissolved with auxiliary agents of iodide of alkali metals, such as potassium iodide may be mentioned. As mentioned above, iodine based light absorbing material is formed by interaction between iodine dispersed in the matrix and the matrix resin. Timing of immersing may be before or after the above-mentioned stretching process (3). The iodine based light absorbing material is, in general, remarkably formed by being passed through a stretching process. A concentration of the aqueous system bath including iodine, and a percentage of the auxiliary agents, such as iodide of alkali metals may not especially be limited, but general iodine dyeing techniques may be adopted, and the above-mentioned concentration etc. may arbitrarily be changed.

Moreover, a percentage of the iodine in the polarizer obtained is not especially limited, but a percentage of the optically-transparent water-soluble resin and the iodine are preferably controlled so that the iodine is 0.05 to 50 parts by weight grade to the optically-transparent water-soluble resin 100 parts by weight, and more preferably 0.1 to 10 parts by weight.

In a case the absorbing dichroic dye is used as the absorbing dichroic material, a percentage of the absorbing dichroic dye in the polarizer obtained is not especially limited, but a percentage of the optically-transparent thermoplastic resin and the absorbing dichroic dye is preferably so that the absorbing dichroic dye is 0.01 to 100 parts by weight grade to the optically-transparent thermoplastic resin 100 parts by weight, and more preferably 0.05 to 50 parts by weight.

In production of the polarizer, processes for various purposes (5) may be given other than the above-mentioned processes (1) to (4). As a process (5), for example, a process in which a film is immersed in water bath and swollen may be mentioned for the purpose of mainly improving iodine dyeing efficiency of the film. Besides, a process in which a film is immersed in a water bath including arbitrary additives dissolved therein may be mentioned. A process in which a film is immersed in an aqueous solution including additives, such as boric acid and borax, for the purpose of cross-linking a water-soluble resin (matrix) may be mentioned. Moreover, for the purpose of mainly adjusting an amount balance of the dispersed iodine based light absorbing materials, and adjusting a hue, a process in which a film is immersed to an aqueous solution including additives, such as an iodide of an alkaline metals may be mentioned.

As for the process (3) of orienting (stretching) of the above-mentioned film, the process (4) of dispersing and dyeing the iodine based light absorbing material to a matrix resin and the above-mentioned process (5), so long as each of the processes (3) and (4) is provided at least 1 time, respectively, a number, order and conditions (a bath temperature, immersion period of time, etc.) of the processes, may arbitrarily be selected, each process may separately be performed and furthermore a plurality of processes may simultaneously be performed. For example, a cross-linking process of the process (5) and the stretching process (3) may be carried out simultaneously.

In addition, although the iodine based light absorbing material used for dyeing, boric acid used for cross-linking are permeated into a film by immersing the film in an aqueous solution as mentioned above, instead of this method, a method may be adopted that arbitrary types and amounts may be added before film formation of the process (2) and before or after preparation of a mixed solution in the process (1). And both methods may be used in combination. However, when high temperatures (for example, 80° C. or more) is required in the process (3) at the time of stretching etc., in the view point of heat resistance of the iodine based light absorbing material, the process (4) for dispersing and dyeing the iodine based light absorbing material may be desirably performed after the process (3).

A film given the above treatments is desirably dried using suitable conditions. Drying is performed according to conventional methods.

A thickness of the obtained polarizer (film) is not especially limited, in general, but it is 1 μm to 3 mm, preferably 5 μm to 1 mm, and more preferably 10 to 500 μm.

A polarizer obtained in this way does not especially have a relationship in size between a refractive index of the birefringent material forming minute domains and a refractive index of the matrix resin in a stretching direction, whose stretching direction is in a Δn¹ direction and two directions perpendicular to a stretching axis are Δn² directions. Moreover, the stretching direction of n iodine based light absorbing material is in a direction demonstrating maximal absorption, and thus a polarizer having a maximally demonstrated effect of absorption and scattering may be realized.

As the protective film, preferably used is that has an in-plane retardation Re=(nx−ny)×d is 20 nm or less and a thickness direction retardation Rth={(nx+ny)/2−nz}×d is 30 nm or less, where a direction of a transparent protective film in which an in-plane refractive index within the film surface concerned gives a maximum is defined as X-axis, a direction perpendicular to X-axis is defined as Y-axis, a thickness direction of the film is defined as Z-axis, refractive indices in axial direction are defined as nx, ny, and nz, respectively, and a thickness of the film is defined as d (nm).

As the materials forming a protective film, a resin composition containing a thermoplastic resin (A) having a substituted and/or non-substituted imide group in a side chain and a thermoplastic resin (B) having substituted and/or non-substituted phenyl group and nitrile group in a side chain, and the norbornene resin are exemplified. Also, a polyolefin based resin, polyester based resin and polyamide based, which satisfy terms of the invention are exemplified.

A transparent protective film comprising the thermoplastic resins (A) and (B) hardly gives retardation, when the film is affected by a stress caused by dimensional variation of the polarizer, and consequently, when stretching processing is given, an in-plane retardation Re and a thickness direction retardation Rth can be controlled small. Transparent protective films comprising the thermoplastic resins (A) and (B) are described in, for example, WO 01/37007. In addition, the transparent protective film may also comprise other resins, when it comprises thermoplastic resins (A) and (B) as principal components.

The thermoplastic resin (A) has substituted and/or non-substituted imide group in a side chain, and a principal chain may be of arbitrary thermoplastic resins. The principal chain may be, for example, of a principal chain consisting only of carbon atoms, or otherwise atoms other than carbon atoms may also be inserted between carbon atoms. And it may also comprise atoms other than carbon atoms. The principal chain is preferably of hydrocarbons or of substitution products thereof. The principal chain may be, for example, obtained by an addition polymerization. Among concrete examples are polyolefins and polyvinyls. And the principal chain may also be obtained by a condensation polymerization. It may be obtained by, for example, ester bonds, amide bonds, etc. The principal chain is preferably of polyvinyl skeletons obtained by polymerization of substituted vinyl monomers.

As methods for introducing substituted and/or non-substituted imide group into the thermoplastic resin (A), well-known conventional and arbitrary methods may be employed. As examples for those methods, there may be mentioned a method in which monomers having the above-mentioned imide group are polymerized, a method in which the above-mentioned imide group is introduced after a principal chain is formed by polymerization of various monomers, and a method in which compounds having the above-mentioned imide group is grafted to a side chain. As substituents for imide group, well-known conventional substituents that can substitute a hydrogen atom of the imide group may be used. For example, alkyl groups, etc. may be mentioned as examples.

The thermoplastic resin (A) is preferably of two or more component copolymers including a repeating unit induced from at least one kind of olefin, and a repeating unit having at least one kind of substituted and/or non-substituted maleimide structure. The above-mentioned olefin-maleimide copolymers may be synthesized from olefins and maleimide compounds using well-known methods. The synthetic process is described in, for example, Japanese Patent Laid-Open Publication No. H5-59193, Japanese Patent Laid-Open Publication No. H5-195801, Japanese Patent Laid-Open Publication No. H6-136058, and Japanese Patent Laid-Open Publication No. H9-328523 official gazettes.

As olefins, for example, there may be mentioned, isobutene, 2-methyl-1-butene, 2-methyl-1-pentene, 2-methyl-1-hexene, 2-methyl-1-heptene, 1-iso octene, 2-methyl-1-octene, 2-ethyl-1-pentene, 2-ethyl-2-butene, 2-methyl-2-pentene, and 2-methyl-2-hexene etc. Among them, isobutene is preferable. These olefins may be used independently and two or more kinds may be used in combination.

As maleimide compounds, there may be mentioned, maleimide, N-methyl maleimide, N-ethylmaleimide, N-n-propyl maleimide, N-i-propyl maleimide, N-n-butyl maleimide, N-s-butyl maleimide, N-t-butyl maleimide, N-n-pentyl maleimide, N-n-hexyl maleimide, N-n-heptyl maleimide, N-n-octyl maleimide, N-lauryl maleimide, N-stearyl maleimide, N-cyclo propyl maleimide, N-cyclobutyl maleimide, N-cyclopentyl maleimide, N-cyclohexyl maleimide, N-cycloheptyl maleimide, and N-cyclooctyl maleimide, etc. Among them N-methyl maleimide is preferable. These maleimide compounds may be used independently and two or more kinds may be used in combination.

A content of repeating units of olefin in the olefin-maleimide copolymer is not especially limited, and it is approximately 20 to 70 mole % in all of repeating units in the thermoplastic resin (A), preferably 40 to 60 mole %, and more preferably 45 to 55 mole %. A content of repeating units of maleimide structure is approximately 30 to 80 mole %, preferably 40 to 60 mole %, and more preferably 45 to 55 mole %.

The thermoplastic resin (A) comprises repeating units of the above-mentioned olefin, and repeating units of maleimide structure, and it may be formed only of these units. And in addition to the above constitution, other vinyl based monomeric repeating units may be included at a percentage of 50 mole % or less. As other vinyl based monomers, there may be mentioned, acrylic acid based monomers, such as methyl acrylate and butyl acrylate; methacrylic acid based monomers, such as methyl methacrylate and cyclo hexyl methacrylate; vinyl ester monomers, such as vinyl acetate; vinyl ether monomers, such as methyl vinyl ether; acid anhydrides, such as maleic anhydride; styrene based monomers, such as styrene, α-methyl styrene, and p-methoxy styrene etc.

A weight average molecular weight of the thermoplastic resin (A) is not especially limited, and it is approximately 1×10³ to 5×10⁶. The above-mentioned weight average molecular weight is preferably 1×10⁴ or more and 5×10⁵ or more. A glass transition temperature of the thermoplastic resin (A) is 80° C. or more, preferably 100° C. or more, and more preferably 130° C. or more.

And glutar imide based thermoplastic resins may be used as the thermoplastic resin (A). Glutar imide based resins are described in Japanese Patent Laid-Open Publication No. H2-153904 etc. Glutar imide based resins have glutar imide structural units and methyl acrylate or methyl methacrylate structural units. The above-mentioned other vinyl based monomers may be introduced also into the glutar imide based resins.

The thermoplastic resin (B) is a thermoplastic resin having substituted and/or non-substituted phenyl group, and nitrile group in a side chain. As a principal chain of the thermoplastic resin (B), similar principal chains as of the thermoplastic resin (A) may be illustrated.

As a method of introducing the above-mentioned phenyl group into the thermoplastic resin (B), for example, there may be mentioned a method in which monomers having the above-mentioned phenyl group is polymerized, a method in which phenyl group is introduced after various monomers are polymerized to form a principal chain, and a method in which compounds having phenyl group are grafted into a side chain, etc. As substituents for phenyl group, well-known conventional substituents that can substitute a hydrogen atom of the phenyl group may be used. For example, alkyl groups, etc. may be mentioned as examples. As method for introducing nitrile groups into the thermoplastic resin (B), similar methods for introducing phenyl groups may be adopted.

The thermoplastic resin (B) is preferably of two or more components copolymers comprising repeating unit (nitrile unit) induced from unsaturated nitrile compounds, and repeating unit (styrene based unit) induced from styrene based compounds. For example, acrylonitrile styrene based copolymers may preferably be used.

As unsaturated nitrile compounds, arbitrary compounds having cyano groups and reactive double bonds may be mentioned. For example, acrylonitrile, α-substituted unsaturated nitrites, such as methacrylonitrile, nitrile compounds having has α- and β-disubstituted olefin based unsaturated bond, such as fumaronitrile may be mentioned.

As styrene based compound, arbitrary compounds having a phenyl group and a reactive double bond may be mentioned. For example, there may be mentioned, non-substituted or substituted styrene based compounds, such as styrene, vinyltoluene, methoxy styrene, and chloro styrene; α-substituted styrene based compounds, such as α-methyl styrene.

A content of a nitrile unit in the thermoplastic resin (B) is not especially limited, and it is approximately 10 to 70% by weight on the basis of all repeating units, preferably 20 to 60% by weight, and more preferably 20 to 50% by weight. It is further preferably 20 to 40% by weight, and still further preferably 20 to 30% by weight. A content of a styrene based unit is approximately 30 to 80% by weight, preferably 40 to 80% by weight, and more preferably 50 to 80% by weight. It is especially 60 to 80% by weight, and further preferably 70 to 80% by weight.

The thermoplastic resin (B) comprise repeating units of the above-mentioned nitrites, and styrene based repeating units, and it may be formed only of these units. And in addition to the above constitution, other vinyl based monomeric repeating units may be included at a percentage of 50 mole % or less. As other vinyl based monomers, compounds, repeating units of olefins, repeating units of maleimide and substituted maleimides, etc. may be mentioned, which were illustrated in the case of thermoplastic resin (A). As the thermoplastic resins (B), AS resins, ABS resins, ASA resins, etc. may be mentioned.

A weight average molecular weight of the thermoplastic resin (B) is not especially limited, and it is approximately 1×10³ to 5×10⁶. It is preferably 1×10⁴ or more, and 5×10⁵ or less.

A compounding ratio of the thermoplastic resin (A) and the thermoplastic resin (B) is adjusted depending on a retardation required for a transparent protective film. In the above-mentioned compounding ratio, in general, a content of the thermoplastic resin (A) is preferably 50 to 95% by weight in total amount of a resin in a film, more preferably 60 to 95% by weight, and still more preferably 65 to 90% by weight. A content of the thermoplastic resin (B) is preferably 5 to 50% by weight in total amount of the resin in the film, more preferably 5 to 40% by weight, and still more preferably 10 to 35% by weight. The thermoplastic resin (A) and the thermoplastic resin (B) are mixed using a method in which these are kneaded in thermally molten state.

Examples of the norbornene resin include resins that are produced by the steps of providing a ring-opened (co)polymer of a norbornene monomer, optionally subjecting the (co)polymer to modification such as maleic acid addition or cyclopentadiene addition, and then hydrogenating the optionally modified (co)polymer; resins produced by addition polymerization of a norbornene monomer; resins produced by addition polymerization of a norbornene monomer and an olefin monomer such as ethylene and α-olefin; and resins produced by addition polymerization of a norbornene monomer and a cyclic olefin monomer such as cyclopentene, cyclooctene, and 5,6-dihydrodicyclopentadiene. Examples of the thermoplastic saturated norbornene resin include ZEONEX and ZEONOR series manufactured by Zeon Corporation and ARTON series manufactured by JSR Corporation.

Examples of the polyolefin based resin include homopolymers or copolymers of α-olefin(s) of 1 to 6 carbon atoms, such as polyethylene, polypropylene, ethylene-propylene copolymers, and poly(4-methylpentene-1). Examples of the polyester based resin include polyethylene terephthalate, polyethylene naphthalate, polybutylene terephthalate, and polyethylene terephthalate-isophthalate copolymers. Various types of polyamide based resins may also be used.

Any other protective film having good transparency, mechanical strength, thermal stability, or water-blocking properties may also preferably be used. Examples of the material for forming the protective film include cellulose polymers such as cellulose diacetate and cellulose triacetate, acrylic polymers such as polymethylmethacrylate, styrene polymers such as polystyrene and acrylonitrile-styrene copolymers (AS reins), polycarbonate polymers. And exemplified are vinyl chloride polymers, imide polymers, sulfone polymers, polyethersulfone polymers, polyetheretherketone polymers, polyphenylenesulfide polymers, vinyl alcohol polymers, vinylidene chloride polymers, vinyl butyral polymers, arylate polymers, polyoxymethylene polymers, and epoxy polymers.

The thickness of the protective film is generally, but not limited to, from 1 to 500 μm, preferably from 1 to 300 μm, particularly preferably from 5 to 300 μm, in terms of forming a thin polarizing plate or the like. If protective films are formed on both sides of the polarizer, the front and rear protective films may be made of different polymers or the like.

A hard coat layer may be prepared, or antireflection processing, processing aiming at sticking prevention, diffusion or anti glare may be performed onto the face on which the polarizer of the above described protective film has not been adhered.

A hard coat processing is applied for the purpose of protecting the surface of the polarizing plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarizing plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarizing plate to disturb visual recognition of transmitting light through the polarizing plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight part. An anti glare layer may serve as a diffusion layer (viewing angle expanding function etc.) for diffusing transmitting light through the polarizing plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective layer.

In order to improve the adhesiveness to the protective film, the surface to be bonded may be subjected to corona treatment, plasma treatment, flame treatment, primer coating treatment, or saponification treatment. For example, the corona treatment may be performed by a method of producing an electrical discharge in normal pressure air with a corona treatment system. For example, the plasma treatment may be performed by a method of producing an electrical discharge in normal pressure air with a plasma discharge system. For example, the flame treatment may be performed by a method of bringing a flame directly into contact with the film surface. For example, the primer coating treatment may be performed by a method including the steps of diluting an isocyanate compound, a silane coupling agent or the like with a solvent and applying the diluted material thin. For example, the saponification treatment may be performed by a method of immersing the surface in an aqueous sodium hydroxide solution.

The polarizer and the protective film are bonded together using an adhesive that contains a resin curable with an active energy beam or an active material. Such an adhesive may be of various types such as urethane, acrylic, epoxy, and silicone types. The active energy beam may be ultraviolet light, an electron beam, or the like, and the adhesive curable with such an active energy beam may contain a resin having a functional group curable with the active energy beam, such as (meth)acryloyl group, vinyl group and epoxy group. The active energy beam-curable adhesive is preferably solventless. The active energy beam-curable adhesive may contain an initiator as needed. The adhesive containing an active material-curable resin may be a moisture-curable adhesive that works with an active material of water or the like.

The adhesive is preferably a moisture-curable adhesive, more preferably a moisture-curable one-component adhesive, which is preferably a moisture-curable one-component silicone adhesive. The moisture-curable adhesive is particularly effective, when a polyvinyl alcohol-based polarizer produced by wet stretching is used. In this case, the polarizer essentially contains water, and therefore in contrast to the case where other types of adhesives are used, the process of applying an active energy beam, heat or the like for curing may be omitted, and water supply such as humidification is not necessary, and the curing process can be completed only by allowing the adhesive to stand for a certain time period. If the curing reaction speed of the moisture-curable adhesive used is sufficiently high, the curing can be completed only by the transfer time from the bonding process to the next or later process of forming a final product, so that the method can be very effective in terms of manufacturing cost, because equipment, energy and time specifically for curing can be substantially omitted.

The moisture-curable one-component silicone adhesive may be a mixture of organopolysiloxane and a curing agent such as various types of silicone compounds. Examples of the type of the curing agent to be used include an acetic acid type, an oxime type, an alcohol type, an acetone type, an amine type, an amide type, an aminoxy type, a dehydrogenated type, and a dehydrated type. Specific examples thereof include an acetic acid type mixed with methyltriacetoxysilane, vinyltriacetoxysilane or the like, an oxime type mixed with methyltris(ethylmethyloxime)silane, vinyltris(ethylmethyloxime)silane, or the like, an alcohol type mixed with methyltrimethoxysilane, vinyltrimethoxysilane or the like, an amide type mixed with dimethylbis(N-ethylacetamino)silane, vinylmethylbis(N-ethylacetamino)silane or the like, and an acetone type mixed with methyltris{(1-methylvinyl)oxy}silane, vinyltris{(1-methylvinyl)oxy}silane or the like. In terms of adhesiveness and resistance to moisture and heat, the acetic acid, alcohol, acetone, or oxime type moisture-curable one-component silicone adhesive is particularly preferred. For the purpose of improving the adhesiveness, any silane coupling agent may be added as needed. Examples of the commercially available silicone adhesive include Silex White (Konishi Co., Ltd.), Silex Clear (Konishi Co., Ltd.), One-Component RTV Rubber KE-41-T (Shin-Etsu Chemical Co., Ltd.), One-Component RTV Rubber KE-3475-T (Shin-Etsu Chemical Co., Ltd.), and CEMEDINE Super X (CEMEDINE Co., Ltd.).

The active energy beam-curable adhesive may be appropriately an acrylic, methacrylic, urethane, epoxy, polyester, or polyvinyl based adhesive. For the purpose of increasing the efficiency of the curing reaction with the active energy beam, any of various types of initiators may be added. Examples of the commercially available active energy beam-curable adhesive include Takenate M631N manufactured by MITSUI TAKEDA CHEMICALS, INC., DA-314 manufactured by Nagase ChemteX Corporation, Norland Optical Adhesive 81 manufactured by Norland Products Inc., Y-101, Y-103, 1071, and 1072 manufactured by Dainippon Ink and Chemicals, Incorporated, IK419 and IK500 manufactured by TOYO INK MFG. Co., Ltd., and 828 manufactured by Japan Epoxy Resins Co., Ltd.

Any other additive or any catalyst such as an acid may be added as needed when the adhesive is prepared.

The polarizing plate of the invention is produced by bonding the protective film and the polarizer together with the adhesive. The adhesive may be applied to either or both of the protective film and the polarizer. After the bonding, a drying process may be performed as needed, and an adhesive layer is formed. The polarizer and the protective film may be bonded together with a roll laminator or the like. The thickness of the adhesive layer is generally, but not limited to, from about 0.05 to about 20 μm, preferably from 0.1 to 10 μm.

When the active energy beam-curable adhesive is used, the adhesive layer is cured with an active energy beam after the bonding. The dose of the active energy beam irradiation is generally determined depending on the type of the active energy beam to be used, the type or the coating thickness of the active energy beam-curable adhesive, or the type or the thickness of the protective film. When ultraviolet light is used as the active energy beam, for example, the dose of the UV irradiation is generally from 1 to 10,000 mJ/cm², preferably from 10 to 7,500 mJ/cm², more preferably from 50 to 5,000 mJ/cm², depending mainly on the UV transmittance and thickness of the protective film used. When an electron beam is used as the active energy beam, the dose of the electron beam irradiation is generally from 1 to 500 kGy, preferably from 3 to 300 kGy, more preferably from 5 to 150 kGy, depending mainly on the thickness of the protective film used. If the irradiation dose is too low, attenuation of the active energy beam through the protective film can lead to insufficient irradiation of the adhesive so that the curing can be insufficient. If the irradiation dose is too high, the protective film or the polarizer can be degraded or decomposed so that an undesirable change in the optical properties can occur.

A polarizing plate of the present invention may be used in practical use as an optical film laminated with other optical layers. Although there is especially no limitation about the optical layers, one layer or two layers or more of optical layers, which may be used for formation of a liquid crystal display etc., such as a reflector, a transfiective plate, a retardation plate (a half wavelength plate and a quarter wavelength plate included), and a viewing angle compensation film, may be used. Especially preferable polarizing plates are; a reflection type polarizing plate or a transfiective type polarizing plate in which a reflector or a transfiective reflector is further laminated onto a polarizing plate of the present invention; an elliptically polarizing plate or a circular polarizing plate in which a retardation plate is further laminated onto the polarizing plate; a wide viewing angle polarizing plate in which a viewing angle compensation film is further laminated onto the polarizing plate; or a polarizing plate in which a brightness enhancement film is further laminated onto the polarizing plate.

A reflective layer is prepared on a polarizing plate to give a reflection type polarizing plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarizing plate may be formed using suitable methods, such as a method in which a reflective layer of metal etc. is, if required, attached to one side of a polarizing plate through a transparent protective layer etc.

In addition, a transflective type polarizing plate may be obtained by preparing the above-mentioned reflective layer as a transflective type reflective layer, such as a half-mirror etc. that reflects and transmits light. A transfiective type polarizing plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarizing plate. That is, the transflective type polarizing plate is useful to obtain of a liquid crystal display of the type that saves energy of light sources, such as a back light, in a well-lighted atmosphere, and can be used with a built-in light source if needed in a comparatively dark atmosphere etc.

The above-mentioned polarizing plate may be used as elliptically polarizing plate or circularly polarizing plate on which the retardation plate is laminated. A description of the above-mentioned elliptically polarizing plate or circularly polarizing plate will be made in the following paragraph. These polarizing plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarizing plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarizing plate in which three-dimensional refractive index is controlled may also preferably compensate (prevent) coloring produced when a screen of a liquid crystal display is viewed from an oblique direction. Circularly polarizing plate is effectively used, for example, when adjusting a color tone of a picture of a reflection type liquid crystal display that provides a colored picture, and it also has function of antireflection. For example, a retardation plate may be used that compensates coloring and viewing angle, etc. caused by birefringence of various wavelength plates or liquid crystal layers etc. Besides, optical characteristics, such as retardation, may be controlled using laminated layer with two or more sorts of retardation plates having suitable retardation value according to each purpose. As retardation plates, birefringence films formed by stretching films comprising suitable polymers, such as polycarbonates, norbornene type resins, polyvinyl alcohols, polystyrenes, poly methyl methacrylates, polypropylene; polyarylates and polyamides; oriented films comprising liquid crystal materials, such as liquid crystal polymer; and films on which an alignment layer of a liquid crystal material is supported may be mentioned. A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarizing plate and an above-mentioned reflected type elliptically polarizing plate are laminated plate combining suitably a polarizing plate or a reflection type polarizing plate with a retardation plate. This type of elliptically polarizing plate etc. may be manufactured by combining a polarizing plate (reflected type) and a retardation plate, and by laminating them one by one separately in the manufacture process of a liquid crystal display. On the other hand, the polarizing plate in which lamination was beforehand carried out and was obtained as an optical film, such as an elliptically polarizing plate, is excellent in a stable quality, a workability in lamination etc., and has an advantage in improved manufacturing efficiency of a liquid crystal display.

A viewing angle compensation film is a film for extending viewing angle so that a picture may look comparatively clearly, even when it is viewed from an oblique direction not from vertical direction to a screen. As such a viewing angle compensation retardation plate, in addition, a film having birefringence property that is processed by uniaxial stretching or orthogonal bidirectional stretching and a biaxially stretched film as inclined orientation film etc. may be used. As inclined orientation film, for example, a film obtained using a method in which a heat shrinking film is adhered to a polymer film, and then the combined film is heated and stretched or shrunk under a condition of being influenced by a shrinking force, or a film that is oriented in oblique direction may be mentioned. The viewing angle compensation film is suitably combined for the purpose of prevention of coloring caused by change of visible angle based on retardation by liquid crystal cell etc. and of expansion of viewing angle with good visibility.

Besides, a compensation plate in which an optical anisotropy layer consisting of an alignment layer of liquid crystal polymer, especially consisting of an inclined alignment layer of discotic liquid crystal polymer is supported with triacetyl cellulose film may preferably be used from a viewpoint of attaining a wide viewing angle with good visibility.

The polarizing plate with which a polarizing plate and a brightness enhancement film are adhered together is usually used being prepared in a backside of a liquid crystal cell. A brightness enhancement film shows a characteristic that reflects linearly polarized light with a predetermined polarization axis, or circularly polarized light with a predetermined direction, and that transmits other light, when natural light by back lights of a liquid crystal display or by reflection from a back-side etc., comes in. The polarizing plate, which is obtained by laminating a brightness enhancement film to a polarizing plate, thus does not transmit light without the predetermined polarization state and reflects it, while obtaining transmitted light with the predetermined polarization state by accepting a light from light sources, such as a backlight. This polarizing plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarizing plate simultaneously supplies polarized light that is difficult to be absorbed in a polarizer, and increases the quantity of the light usable for a liquid crystal picture display etc., and as a result luminosity may be improved.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film having a different refractive-index anisotropy; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In the polarizing plate mentioned above and the optical film in which at least one layer of the polarizing plate is laminated, an adhesive layer may also be prepared for adhesion with other members, such as a liquid crystal cell etc. As pressure sensitive adhesive that forms adhesive layer is not especially limited, and, for example, acrylic type polymers; silicone type polymers; polyesters, polyurethanes, polyamides, polyethers; fluorine type and rubber type polymers may be suitably selected as a base polymer. Especially, a pressure sensitive adhesive such as acrylics type pressure sensitive adhesives may be preferably used, which is excellent in optical transparency, showing adhesion characteristics with moderate wettability, cohesiveness and adhesive property and has outstanding weather resistance, heat resistance, etc.

Moreover, an adhesive layer with low moisture absorption and excellent heat resistance is desirable. This is because those characteristics are required in order to prevent foaming and peeling-off phenomena by moisture absorption, in order to prevent decrease in optical characteristics and curvature of a liquid crystal cell caused by thermal expansion difference etc. and in order to manufacture a liquid crystal display excellent in durability with high quality.

The adhesive layer may contain additives, for example, such as natural or synthetic resins, adhesive resins, glass fibers, glass beads, metal powder, fillers comprising other inorganic powder etc., pigments, colorants and antioxidants. Moreover, it may be an adhesive layer that contains fine particle and shows optical diffusion nature.

Proper method may be carried out to attach an adhesive layer to one side or both sides of the optical film. As an example, about 10 to 40 weight % of the pressure sensitive adhesive solution in which a base polymer or its composition is dissolved or dispersed, for example, toluene or ethyl acetate or a mixed solvent of these two solvents is prepared. A method in which this solution is directly applied on a polarizing plate top or an optical film top using suitable developing methods, such as flow method and coating method, or a method in which an adhesive layer is once formed on a separator, as mentioned above, and is then transferred on a polarizing plate or an optical film may be mentioned.

An adhesive layer may also be prepared on one side or both sides of a polarizing plate or an optical film as a layer in which pressure sensitive adhesives with different composition or different kind etc. are laminated together. Moreover, when adhesive layers are prepared on both sides, adhesive layers that have different compositions, different kinds or thickness, etc. may also be used on front side and backside of a polarizing plate or an optical film. Thickness of an adhesive layer may be suitably determined depending on a purpose of usage or adhesive strength, etc., and generally is 1 to 500 μm, preferably 5 to 200 μm, and more preferably 10 to 100 μm.

A temporary separator is attached to an exposed side of an adhesive layer to prevent contamination etc., until it is practically used. Thereby, it can be prevented that foreign matter contacts adhesive layer in usual handling. As a separator, without taking the above-mentioned thickness conditions into consideration, for example, suitable conventional sheet materials that is coated, if necessary, with release agents, such as silicone type, long chain alkyl type, fluorine type release agents, and molybdenum sulfide may be used. As a suitable sheet material, plastics films, rubber sheets, papers, cloths, no woven fabrics, nets, foamed sheets and metallic foils or laminated sheets thereof may be used.

In addition, in the present invention, ultraviolet absorbing property may be given to the above-mentioned each layer, such as a polarizer for a polarizing plate, a transparent protective film and an optical film etc. and an adhesive layer, using a method of adding UV absorbents, such as salicylic acid ester type compounds, benzophenol type compounds, benzotriazol type compounds, cyano acrylate type compounds, and nickel complex salt type compounds.

A polarizing plate or an optical film of the present invention may be preferably used for manufacturing various equipment, such as liquid crystal display, etc. Assembling of a liquid crystal display may be carried out according to conventional methods. That is, a liquid crystal display is generally manufactured by suitably assembling several parts such as a liquid crystal cell, optical films and, if necessity, lighting system, and by incorporating driving circuit. In the present invention, except that a polarizing plate or an optical film by the present invention is used, there is especially no limitation to use any conventional methods. Also any liquid crystal cell of arbitrary type, such as TN type, and STN type, 7 type may be used.

Suitable liquid crystal displays, such as liquid crystal display with which the above-mentioned a polarizing plate or an optical film has been located at one side or both sides of the liquid crystal cell, and with which a backlight or a reflector is used for a lighting system may be manufactured. In this case, the polarizing plate or the optical film by the present invention may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, an organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

This means that only linearly polarized light component of the external light that enters as incident light into this organic EL display is transmitted with the work of polarizing plate. This linearly polarized light generally gives an elliptically polarized light by the retardation plate, and especially the retardation plate is a quarter wavelength plate, and moreover when the angle between the two polarization directions of the polarizing plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarizing plate, it cannot be transmitted through the polarizing plate. As the result, mirror surface of the metal electrode may be completely covered.

### EXAMPLES

Examples of this invention will, hereinafter, be shown, and specific descriptions will be provided. In addition, “parts” in following sections represents parts by weight.

The indices nx, ny and nz of the protective film were measured with an automatic birefringence measurement system (Automatic Birefringence Analyzer KOBRA 2 1ADH manufactured by Oji Scientific Instruments), and the in-plane retardation Re and the thickness direction retardation Rth were calculated.

### Example 1

(Polarizer)

A polyvinyl alcohol aqueous solution with a solid matter content of 13 weight % in which a polyvinyl alcohol resin with a polymerization degree of 2400 and a saponification degree of 98.5%, a liquid crystalline monomer (a nematic liquid crystal temperature is in the range of from 40 to 70°) having an acryloyl group at each of both terminals of a mesogen group and glycerin were mixed together so that a ratio of polyvinyl alcohol: a liquid crystalline monomer: glycerin=100:5:15 (in weight ratio) and the mixture was heated to a temperature equal to or higher than a liquid crystal temperature range and agitated with a homomixer to thereby obtain a mixed solution. Bubbles existing in the mixed solution were defoamed by leaving the solution at room temperature (23° C.) as it was, thereafter, the solution is coated by means of a casting method, subsequently thereto, and the wet coat was dried and to thereafter obtains a whitened mixed film with a thickness of 70 μm. The mixed film was heat-treated at 130° C. for 10 min.

The mixed film was immersed in a water bath at 30° C. and swollen, thereafter, the swollen film was stretched about three times while being immersed in an aqueous solution of iodine and potassium iodide in a ratio of 1 to 7 in weight (a dyeing bath, with a concentration of 0.32 weight %) at 30° C., thereafter the stretched film was further stretched to a total stretch magnification of being about six times while being immersed in a 3 weight % boric acid aqueous solution (crosslinking bath) at 50° C., followed by immersing further the stretched film in 4 weight % boric acid aqueous solution (crosslinking bath) at 60° C. Then, hue adjustment was conducted by immersing the film in 5 weight % potassium iodide aqueous solution bath at 30° C. Subsequent thereto, the film was dried at 50° C. for 4 minutes to obtain a polarizer of the present invention.

(Confirmation of Generation of Anisotropic Scattering and Measurement of Refractive Index)

The obtained polarizer was observed under a polarization microscope and it was able to be confirmed that numberless dispersed minute domains of a liquid crystalline monomer were formed in a polyvinyl alcohol matrix. The liquid crystalline monomer is oriented in a stretching direction and an average size of minute domains in the stretching direction (Δn¹ direction) was in the range of from 5 to 10 μm. And an average size of minute domains in a direction perpendicular to the stretching direction (Δn² direction) was in the range of from 0.5 to 3 μm.

Refractive indices of the matrix and the minute domain were separately measured. Measurement was conducted at 20° C. A refractive index of a stretched film constituted only of a polyvinyl alcohol film stretched in the same conditions as the wet stretching was measured with an Abbe's refractometer (measurement light wavelength with 589 nm) to obtain a refractive index in the stretching direction (Δn¹ direction)=1.54 and a refractive index in Δn² direction=1.52. Refractive indexes (ne: an extraordinary light refractive index and no: an ordinary light refractive index) of a liquid crystalline monomer were measured. An ordinary light refractive index no was measured of the liquid crystalline monomer orientation-coated on a high refractive index glass which is vertical alignment-treated with an Abbe's refractometer (measurement light with 589 nm). On the other hand, the liquid crystalline monomer is injected into a liquid crystal cell which is homogenous alignment-treated and a retardation (Δn×d) was measured with an automatic birefringence measurement instrument (automatic birefringence meter KOBRA21ADH) manufactured by Ohoji Keisokuki K. K.) and a cell gap (d) was measured separately with an optical interference method to calculate Δn from retardation/cell gap and to obtain the sum of Δn and no as nₑ. An extraordinary light refractive index ne (corresponding to a refractive index in the Δn¹ direction)=1.64 and n₀ (corresponding to a refractive index of Δn² direction)=1.52. Therefore, calculation was resulted in Δn¹=1.64−1.54=0.10 and Δn²=1.52−1.52=0.00. It was confirmed from the measurement described above that a desired anisotropic scattering was able to occur.

(Transparent Protective Film)

An alternating copolymer consisting of isobutene and N-methyl maleimide (N-methyl maleimide contents 50 mole %) 75 parts by weight, and an acrylonitrile-styrene copolymer having content of 28% by weight of acrylonitrile 25 parts by weight were dissolved in methylene chloride to obtain a solution having 15% by weight of solid content concentration. After this solution was poured on a polyethylene terephthalate film lay to cover a glass plate and was left at room temperature for 60 minutes, dried film was removed from the film concerned. The film obtained was dried for 10 minutes at 100° C., for 10 minutes at 140° C., and further for 30 minutes at 160° C. to obtain a transparent protective film having a thickness of 100 μm. The transparent protective film thus obtained showed 4 nm of in-plane retardation Re and 4 nm of thickness direction retardation Rth.

(Polarizing Plate)

A polarizing plate was prepared by bonding the protective films to both sides of the polarizer with a moisture-curable acrylic-modified one-component adhesive (Bond Silex Clear (trade name) manufactured by Konishi Co., Ltd.). The thickness of the adhesive layer was 2 μm.

### Example 2

A polarizing plate was prepared using the process of Example 1, except that an 80 μm-thick norbornene type film (ARTON with an in-plane retardation Re of 4 nm and a thickness direction retardation Rth of 20 nm manufactured by JSR Corporation) was alternatively used as the protective film.

### Example 3

A polarizing plate was prepared using the process of Example 1, except that a moisture-curable one-component acetic acid type adhesive (KE-41-T (trade name) manufactured by Shin-Etsu Chemical Co., Ltd.) was alternatively used as the adhesive.

### Example 4

A polarizing plate was prepared using the process of Example 2, except that a moisture-curable one-component acetic acid type adhesive (KE-41-T (trade name) manufactured by Shin-Etsu Chemical Co., Ltd.) was alternatively used as the adhesive.

### Example 5

A polarizing plate was prepared using the process of Example 3, except that an 80 μm-thick triacetylcellulose film (with an in-plane retardation Re of 2 nm and a thickness direction retardation Rth of 40 nm) was alternatively used as the protective film.

### Example 6

A polarizing plate was prepared using the process of Example 1, except that a moisture-curable one-component urethane type adhesive (Takenate M631N manufactured by MITSUI TAKEDA CHEMICALS, INC.) was alternatively used as the adhesive.

### Example 7

A polarizing plate was prepared using the process of Example 2, except that an electron beam-curable solventless acrylic adhesive (DA-314 (trade name) manufactured by Nagase ChemteX Corporation) was alternatively used as the adhesive and that the adhesive was cured by irradiating the laminate of the polarizer and the protective film with 50 kGy of electron beams through the protective film in an electron beam irradiation system (Model CB250/30/20A manufactured by Iwasaki Electric Co., Ltd.).

### Example 8

A polarizing plate was prepared using the process of Example 2, except that an ultraviolet-curable solventless epoxy type adhesive (Norland Optical Adhesive 81 (trade name) manufactured by Norland Products Inc.) was alternatively used as the adhesive and that the adhesive was cured by irradiating the laminate of the polarizer and the protective film with 300 mJ/cm² of ultraviolet rays through the protective film in an UV irradiation system (Model UVC-321AM manufactured by C-SUN).

### Comparative Example 1

A polarizing plate was prepared using the process of Example 1, except that a mixture of polyvinyl alcohol and glyoxal was alternatively used as the adhesive.

### Comparative Example 2

A polarizing plate was prepared using the process of Example 1, except that an acrylic adhesive (Kony Bond (trade name) manufactured by Konishi Co., Ltd.) was alternatively used as the adhesive.

### Comparative Example 3

A polarizing plate was prepared using the process of Comparative Example 1, except that an 80 μm-thick triacetylceliulose film (with an in-plane retardation Re of 2 nm and a thickness direction retardation Rth of 40 nm) was alternatively used as the protective film.

### Comparative Example 4

A polarizing plate was prepared using the process of Example 2, except that a mixture of polyvinyl alcohol and glyoxal was alternatively used as the adhesive.

### Comparative Example 5

A polarizing plate was prepared using the process of Example 2, except that an acrylic adhesive (Kony Bond (trade name) manufactured by Konishi Co., Ltd.) was alternatively used as the adhesive.

### Comparative Example 6

A polarizer was prepared using the process of Example 1, except that the liquid-crystalline monomer was not used. A polarizing plate was prepared using the resulting polarizer by the process of Comparative Example 1.

### Comparative Example 7

A polarizer was prepared using the process of Example 1, except that the liquid-crystalline monomer was not used. A polarizing plate was prepared using the resulting polarizer by the process of Example 1.

(Optical Characteristics Evaluation)

Polarizers obtained in Examples and Comparative examples were measured for optical properties using a spectrophotometer with integrating sphere (manufactured by Hitachi Ltd. U-4100). Transmittance to each linearly polarized light was measured under conditions in which a completely polarized light obtained through Glan Thompson prism polarizer was set as 100%. Transmittance was calculated based on CIE 1931 standard colorimetric system, and is shown with Y value, for which relative spectral responsivity correction was carried out. Notation k₁ represents a transmittance of a linearly polarized light in a maximum transmittance direction, and k₂ represents a transmittance of a linearly polarized light perpendicular to the direction. A result is shown in Table 1.

A polarization degree P was calculated with an equation P={(k₁−k₂)/(k₁+k₂)}×100. A transmittance T of a simple substance was calculated with an equation T=(k₁+k₂)/2.

Furthermore, polarizers obtained in Example 1 and Comparative example 6 were measured for a polarized light absorption spectrum using a spectrophotometer (manufactured by Hitachi Ltd. U-4100) with Glan Thompson prism. In FIG. 2, there are shown the maximum transmittance (k₁): a parallel transmittance and a transmittance of linearly polarized light in a direction perpendicular thereto: a perpendicular transmittance (k₂).

The polarizers of Example 1 and comparative Example 6 are equal in the all visible light range in parallel transmittance (k₁), while on the other hand, the polarizer of Example 1 is greatly smaller in perpendicular transmittance (k₂) than the polarizer of Comparative Example 6 on the shorter wavelength side due to the absorption and scattering axes. This shows that, on the shorter wavelength side, a polarization performance of the polarizer of Example 1 exceeds that of the polarizer of Comparative Example 6. Since conditions for stretching and dyeing of Example 1 are all the same as those of Comparative Example 6, an orientation degree of an iodine based light absorbing material is also considered to be equal. Hence, the perpendicular transmittance (k₂) of the polarizer of Example 1 shows, as described above, that increase in polarization performance is effected by an effect due to addition of an anisotropic scattering effect to absorption by iodine.

In haze values, a haze value to a linearly polarized light in a maximum transmittance direction, and a haze value to a linearly polarized light in an absorption direction (a perpendicular direction). Measurement of a haze value was performed according to JIS K7136 (how to obtain a haze of plastics-transparent material), using a haze meter (manufactured by Murakami Color Research Institute HM-150). A commercially available polarizing plate (NPF-SEG1224DU manufactured by NITTO DENKO CORP.: 43% of simple substance transmittances, 99.96% of polarization degree) was arranged on a plane of incident side of a measurement light of a sample, and stretching directions of the commercially available polarizing plate and the sample (polarizer) were made to perpendicularly intersect, and a haze value was measured. However, since quantity of light at the time of rectangular crossing is less than limitations of sensitivity of a detecting element when a light source of the commercially available haze meter is used, light by a halogen lamp which has high optical intensity provided separately was made to enter with a help of an optical fiber device, thereby quantity of light was set as inside of sensitivity of detection, and subsequently a shutter closing and opening motion was manually performed to obtain a haze value to be calculated.

TABLE 1

| | Linearly polarized light | | | | | |
|---|---|---|---|---|---|---|
| | transmittance (%) | | | | Haze value (%) | |
| | Maximum | | Transmittance | | Maximum | |
| | transmission | Perpendicular | of simple | Polarization | transmission | Perpendicular |
| | direction (k₁) | direction (k₂) | substance (%) | degree (%) | direction | direction |
| Example 1 | 87.19 | 0.034 | 43.6 | 99.92 | 1.8 | 82.0 |
| Example 2 | 87.19 | 0.034 | 43.6 | 99.92 | 1.8 | 82.0 |
| Example 3 | 86.95 | 0.042 | 43.5 | 99.90 | 1.6 | 82.5 |
| Example 4 | 86.95 | 0.042 | 43.5 | 99.90 | 1.6 | 82.5 |
| Example 5 | 87.20 | 0.039 | 43.6 | 99.91 | 1.8 | 82.2 |
| Example 6 | 87.18 | 0.034 | 43.6 | 99.92 | 1.8 | 82.0 |
| Example 7 | 87.17 | 0.033 | 43.6 | 99.92 | 1.8 | 82.2 |
| Example 8 | 87.18 | 0.033 | 43.6 | 99.92 | 1.8 | 82.0 |
| Comparative | 87.19 | 0.034 | 43.6 | 99.92 | 1.8 | 82.0 |
| Example 1 | | | | | | |
| Comparative | 87.19 | 0.034 | 43.6 | 99.92 | 1.8 | 82.0 |
| Example 2 | | | | | | |
| Comparative | 87.20 | 0.039 | 43.6 | 99.91 | 1.8 | 82.2 |
| Example 3 | | | | | | |
| Comparative | 86.95 | 0.042 | 43.5 | 99.90 | 1.6 | 82.5 |
| Example 4 | | | | | | |
| Comparative | 86.95 | 0.042 | 43.5 | 99.90 | 1.6 | 82.5 |
| Example 5 | | | | | | |
| Comparative | 87.21 | 0.042 | 43.6 | 99.90 | 0.3 | 0.2 |
| Example 6 | | | | | | |
| Comparative | 87.28 | 0.034 | 43.7 | 99.92 | 0.2 | 0.2 |
| Example 7 | | | | | | |

In the polarizing plates of the examples and the comparative examples as shown in Table 1, polarization characteristics such as transmittance of simple substances and polarization degrees are almost good. It is understood, however, that in the polarizing plates of Examples 1 to 8 and Comparative examples 1 to 5 since a polarizer is used of a structure in which minute domains are dispersed in a matrix formed with an optically-transparent water-soluble resin containing iodine based light absorbing material, a haze value of a transmittance in perpendicular state is higher than the polarizing plate of Comparative Example 6 and 7 using an ordinary polarizer and unevenness due to fluctuation in haze value is hidden by scattering so as not be recognized.

As a polarizer having a similar structure as a structure of a polarizer of this invention, a polarizer in which a mixed phase of a liquid crystalline birefringent material and an absorption dichroism material is dispersed in a resin matrix is disclosed in Japanese Patent Laid-Open No. 2002-207118, whose effect is similar as that of this invention. However, as compared with a case where an absorption dichroism material exists in dispersed phase as in Japanese Patent Laid-Open No. 2002-207118, since in a case where an absorption dichroism material exists in a matrix layer as in this invention a longer optical path length may be realized by which a scattered polarized light passes absorption layer, more scattered light may be absorbed. Therefore, this invention may demonstrate much higher effect of improvement in light polarizing performance. This invention may be realized with simple manufacturing process.

Although an optical system to which a dichroic dye is added to either of continuous phase or dispersed phase is disclosed in Japanese Patent Laid-Open No. 2000-506990, this invention has large special feature in a point of using not dichroic dye but iodine. The following advantages are realized when using not dichroic dye but iodine. (1) Absorption dichroism demonstrated with iodine is higher than by dichroic dye. Therefore, polarized light characteristics will also become higher if iodine is used for a polarizer obtained. (2) Iodine does not show absorption dichroism, before being added in a continuous phase (matrix phase), and after being dispersed in a matrix, an iodine based light absorbing material showing dichroism is formed by stretching. This point is different from a dichroic dye having dichroism before being added in a continuous phase. That is, iodine exists as iodine itself, when dispersed in a matrix. In this case, in general, iodine has a far effective diffusibility in a matrix compared with a dichroic dye. As a result, iodine based light absorbing material is dispersed to all corners of a film more excellently than dichroic dye. Therefore, an effect of increasing optical path length by scattering anisotropy can be utilized for maximum, which increases polarized light function.

A background of invention given in Japanese Patent Laid-Open No. 2000-506990 describes that optical property of a stretched film in which liquid droplets of a liquid crystal are arranged in a polymer matrix is indicated by Aphonin et al. However, Aphonin et al. has mentioned an optical film comprising a matrix phase and a dispersed phase (liquid crystal component), without using a dichroic dye, and since a liquid crystal component is not a liquid crystal polymer or a polymerized liquid crystal monomer, a liquid crystal component in the film concerned has a sensitive birefringence typically depending on temperatures. On the other hand, this invention provides a polarizer comprising a film having a structure where minute domains are dispersed in a matrix formed of an optically-transparent water-soluble resin including an iodine based light absorbing material, furthermore, in a liquid crystalline material of this invention, in the case of a liquid crystal polymer, after it is orientated in a liquid crystal temperature range, cooled to room temperatures and thus orientation is fixed, in the case of a liquid crystal monomer, similarly, after orientation, the orientation is fixed by ultraviolet curing etc., birefringence of minute domains formed by a liquid crystalline material does not change by the change of temperatures.

(Evaluation)

Each polarizing plate was evaluated as described below. The results are shown in Table 2.

(Adhesive Strength)

According to JIS K 6854, the polarizing plate was cut into a 25 mm-wide piece, which was measured for adhesive strength (N/25 mm) by the T-type peel test at room temperature (23° C.) under the condition of a tensile rate of 100 mm/minute.

(Resistance to Moisture and Heat)

The polarizing plate was cut into a piece with a size of 50 mm×50 mm, which was immersed in hot water at 70° C. when the time (minutes) until the protective film on any one side peeled off was measured.

(Durability)

A cut piece (25 mm×50 mm in size) of the polarizing plate was adhered to a slide glass with an acrylic pressure-sensitive adhesive and then measured for optical properties (the initial optical properties). Thereafter, the piece adhered to the slide glass was placed in a thermo-hygrostat at 60° C./95% RH and measured for the optical properties below (post-test optical properties) after it was held for 1,000 hours in the thermo-hygrostat under the same conditions, and the amounts of changes were calculated as described below.

Amount of Transmittance Change: According to JIS Z 8701, luminosity correction was performed, and light transmittance (hereinafter simply referred to as “transmittance”) was determined. The amount of transmittance change=post-test transmittance-initial transmittance.

Amount of Polarization Degree Change: Degree of polarization was calculated according to the formula: degree of polarization=√((H₀-H₉₀)/(H₀+H₉₀))×100(%), wherein H₀ is parallel transmittance and H₉₀ is perpendicular transmittance. The amount of polarization degree change=post-test degree of polarization-initial degree of polarization.

The unevenness evaluation method included the steps of placing a sample (polarizing plate) on the top face of a backlight for liquid crystal displays in a darkroom, stacking thereon a commercially available polarizing plate (NPF-SEG1224DU manufactured by NITTO DENKO CORPORATION) as an analyzer in such a manner that the polarization axes intersect at right angles, and visually determining the level of unevenness according to the criteria below. Stretching unevenness of the polarizer and interference unevenness due to retardation were evaluated.
x: a level at which unevenness is visually detectable.

∘: a level at which unevenness is not visually detectable.

TABLE 2

| | | | Durability | | | |
|---|---|---|---|---|---|---|
| | | | Amount of | Amount of | Stretching | Interference |
| | Adhesive Strength | Resistance to Moisture | Transmittance | Polarization Degree | Unevenness of | Unevenness by |
| | (N/25 mm) | and Heat (minutes) | Change | Change | Polarizer | Retardation |
| Example 1 | Protective film break | At least 120 minutes | 1.0 | −0.1 | ∘ | ∘ |
| Example 2 | Protective film break | At least 120 minutes | 1.3 | −0.1 | ∘ | ∘ |
| Example 3 | Protective film break | At least 120 minutes | 1.1 | −0.2 | ∘ | ∘ |
| Example 4 | Protective film break | At least 120 minutes | 1.2 | −0.1 | ∘ | ∘ |
| Example 5 | 90 | At least 120 minutes | 2.4 | −2.0 | x | x |
| Example 6 | Protective film break | At least 120 minutes | 1.2 | −0.2 | ∘ | ∘ |
| Example 7 | Protective film break | At least 120 minutes | 1.2 | −0.1 | ∘ | ∘ |
| Example 8 | Protective film break | At least 120 minutes | 1.3 | −0.2 | ∘ | ∘ |
| Comparative | Protective film break | 30 | 2.5 | −2.0 | ∘ | ∘ |
| Example 1 | | | | | | |
| Comparative | 8 | At least 120 minutes | 2.7 | −0.3 | ∘ | ∘ |
| Example 2 | | | | | | |
| Comparative | Protective film break | 29 | 3.9 | −2.7 | x | x |
| Example 3 | | | | | | |
| Comparative | Protective film break | 30 | 2.0 | −1.8 | ∘ | ∘ |
| Example 4 | | | | | | |
| Comparative | 7 | At least 120 minutes | 2.3 | −1.9 | ∘ | ∘ |
| Example 5 | | | | | | |
| Comparative | Protective film break | At least 120 minutes | 2.2 | −1.9 | x | ∘ |
| Example 6 | | | | | | |
| Comparative | Protective film break | At least 120 minutes | 1.2 | −0.1 | x | ∘ |
| Example 7 | | | | | | |

Table 2 shows that the adhesive strength and the resistance to moisture and heat are better in Examples than in Comparative Examples. If the adhesive strength is at least 80 N/25 mm and the resistance to moisture and heat is at least 120 minutes, there can be provided a polarizing plate with good adhesiveness. It is also apparent that the amount of the change in optical properties is smaller in Examples 1 to 4 and 6 to 8 than in Example 5, durability is better in the former than in the latter, and the unevenness is also suppressed smaller in the former than in the latter, because Examples 1 to 4 and 6 to 8 each employ a protective film with a relatively small retardation value.

### INDUSTRIAL APPLICABILITY

The polarizing plate and the optical film using the polarizing plate concerned of the invention are suitable for use in image displays such as liquid crystal displays, organic EL displays, CRTs, and PDPs.

1. A polarizing plate comprising: a polarizer and a protective film laminated on one or both sides of the polarizer with an adhesive layer, wherein
the polarizer comprises a monolayer film having a structure having a minute domain dispersed in a matrix formed of an optically-transparent water-soluble resin including an iodine based light absorbing material, and
the adhesive layer is made of an adhesive that contains a resin curable with an active energy beam or an active material.

2. The polarizing plate according to claim 1, wherein the minute domain of the polarizer is formed of an oriented birefringent material.

3. The polarizing plate according to claim 2, wherein the birefringent material shows liquid crystalline at least in orientation processing step.

4. The polarizing plate according to claim 2, wherein the minute domain of the polarizer has 0.02 or more of birefringence.

5. The polarizing plate according to claim 2, wherein in a refractive index difference between the birefringent material forming the minute domain and the optically-transparent water-soluble resin of the polarizer in each optical axis direction,
a refractive index difference (Δn¹) in direction of axis showing a maximum is 0.03 or more, and
a refractive index difference (Δn²) between the Δn¹ direction and a direction of axes of two directions perpendicular to the Δn¹ direction is 50% or less of the Δn¹.

6. The polarizing plate according to claim 5, wherein an absorption axis of the iodine based light absorbing material of the polarizer is oriented in the Δn¹ direction.

7. The polarizing plate according to claim 1, wherein the film used as the polarizer is manufactured by stretching.

8. The polarizing plate according to claim 5, wherein the minute domain of the polarizer has a length of 0.05 to 500 μm in the Δn² direction.

9. The polarizing plate according to claim 1, wherein an iodine based light absorbing material of the polarizer has an absorbing band at least in a band of 400 to 700 nm wavelength range.

10. The polarizing plate according to claim 1, wherein the adhesive is an active energy beam-curable solventless adhesive or a moisture-curable one-component adhesive.

11. The polarizing plate according to claim 1, wherein the protective film has a bonded surface that has been subjected to at least one treatment selected from corona treatment, plasma treatment, flame treatment, primer coating treatment, and saponification treatment.

12. The polarizing plate according to claim 1, wherein the protective film has an in-plane retardation Re=(nx−ny)×d is 20 nm or less and a thickness direction retardation Rth={(nx+ny)/2−nz}×d is 30 nm or less,
where a direction of a transparent protective film in which an in-plane refractive index within the film surface concerned gives a maximum is defined as X-axis, a direction perpendicular to X-axis is defined as Y-axis, a thickness direction of the film is defined as Z-axis, refractive indices in axial direction are defined as nx, ny, and nz, respectively, and a thickness of the film is defined as d (nm).

13. The polarizing plate according to claim 12, wherein the protective film comprises at least one selected from a resin composition containing a thermoplastic resin (A) having a substituted and/or non-substituted imide group in a side chain and a thermoplastic resin (B) having substituted and/or non-substituted phenyl group and nitrile group in a side chain, and the norbornene resin.

14. The polarizing plate according to claim 1, wherein a transmittance to a linearly polarized light in a transmission direction is 80% or more, a haze value is 5% or less, and
a haze value to a linearly polarized light in an absorption direction is 30% or more.

15. An optical film comprising at least one of the polarizing plate according to claim 1.

16. An image display comprising at least one polarizing plate according to claim 1.

17. An image display comprising at least one optical film according to claim 15.
